(19) United States
(12) Patent Application Publication
(10) Pub. No.: US 2025/0330225 A1
(43) Pub. Date: Oct. 23, 2025

(54) TECHNIQUES FOR JOINT DETERMINATION OF SPATIAL AND FREQUENCY VISIBLE REGIONS

(71) Applicant: Lenovo (United States) Inc., Morrisville, NC (US)

(72) Inventors: Khaled Nafez Rauf Ardah, Schwieberdingen (DE); Seyedomid Taghizadeh Motlagh, Oberursel (DE)

(21) Appl. No.: 19/252,598

(22) Filed: Jun. 27, 2025

(51) Int. Cl. H04B 7/06; H04B 17/309; H04B 17/318; H04W 24/10

(52) U.S. Cl. CPC H04B 7/0626; H04B 17/328; H04B 17/346; H04W 24/10

(57) ABSTRACT

Various aspects of the present disclosure relate techniques for joint determination of spatial and frequency visible regions. A User Equipment (UE) can receive, from a base station, a first channel state information (CSI) configuration message associated with a plurality of sub-array configurations of an antenna array. Additionally, the UE can perform a first measurement during a first measurement occasion. The first measurement occasion can be associated with a first sub-array configuration of the plurality of sub-array configurations and a first frequency region. Moreover, the UE can transmit, to the base station, a first CSI report. The first CSI report can be based on the first measurement.

### TECHNICAL FIELD

The present disclosure relates to wireless communications, and more specifically to determine spatial visible regions and frequency visible regions in large antenna arrays and large carrier bandwidths.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may be configured to, capable of, or operable to receive, from a base station, a first channel state information (CSI) configuration message associated with a plurality of sub-array configurations of an antenna array. Additionally, the UE can perform a first measurement during a first measurement occasion. The first measurement occasion can be associated with a first sub-array configuration of the plurality of sub-array configurations and a first frequency region. Moreover, the UE can transmit, to the base station, a first CSI report, wherein the first CSI report is based on the first measurement.

In some instances, the first frequency region can be greater than a predetermined number (e.g., 16, 32, 64, 128) of resource blocks (RBs).

In some instances, the first sub-array configuration of the plurality of sub-array configurations can include a first number of antenna ports. Additionally, a second sub-array configuration of the plurality of sub-array configurations can include a second number of antenna ports. Moreover, the UE can perform a second measurement during a second measurement occasion. The second measurement occasion can be associated with the second sub-array configuration and the first frequency region. Furthermore, the first CSI report can be further based on the second measurement for the second measurement occasion.

In some instances, the UE can generate the CSI report based on the first measurement and the second measurement.

In some instances, the first sub-array configuration can include a first downlink transmission power value. Additionally, a second sub-array configuration of the plurality of sub-array configurations can include a second downlink transmission power value that is different than the first downlink transmission power value.

In some instances, a first CSI configuration message can include a first resource indication value (RIV). The RIV can indicate a first size (e.g., RB length) of the first frequency region and a first location (e.g., RB start) of the first frequency region. Additionally, the first CSI configuration message can include the first frequency region and a second frequency region. In one example, the first frequency region can partially overlap with the second frequency region. In some examples, the first frequency region does not overlap with the second frequency region.

In some instances, the first CSI configuration message can include the first frequency region and a second frequency region. Additionally, the first CSI configuration message can include a second RIV indicating a second size of the second frequency region, where the first size of the first frequency region is different than the second size of the second frequency region.

In some instances, the first CSI configuration message can include a RB group (RBG) size. Additionally, the UE can determine the first frequency region based on the RBG size.

In some instances, the UE can determine the first frequency region based on a downlink (DL) sub-band, a DL bandwidth (BW) part, and/or a carrier BW.

In some instances, the first CSI configuration message can include a sub-array size. Additionally, the UE can determine the first frequency region based on the sub-array size.

In some instances, the first CSI configuration message can include an indication to a CSI-related table. Additionally, the UE can determine the first frequency region based on the CSI-related table.

In some instances, the first CSI configuration message can include a number of frequency regions. Additionally, the UE can determine the first frequency region based on the number of frequency regions.

In some instances, the first CSI configuration message can be for a first symbol type. Additionally, the UE can determine the first frequency region based on the first symbol type. For example, the first symbol type can be associated with DL-only symbols, and the first frequency region can be designated as a DL resource. Moreover, the UE can receive, from a base station, a second CSI configuration message for a second symbol type. The second symbol type can be associated with Sub-band Full Duplex (SBFD) symbols. Furthermore, the UE can determine a second frequency region based on the second symbol type. The second frequency region can be portioned into a plurality of sub-bands, where a first sub-band in the plurality of sub-bands is designated as a DL sub-band, and a second sub-band in the plurality of sub-bands is designated as an uplink (UL) sub-band.

In some instances, the UE can perform a second measurement for a second measurement occasion. In one example, the second measurement occasion can be associated with the first sub-array configuration and a second frequency region. Additionally, the UE can generate a second CSI report based on the second measurement for the second measurement occasion. Moreover, the UE can transmit, to the base station, the second CSI report associated with a second symbol type.

In some instances, the first CSI configuration message can include a first measurement threshold. Additionally, the UE can determine, using a database mapping, an array of bits (e.g., bitmap indicator) based on the first measurement and the measurement threshold. The CSI report can include the array of bits. Moreover, the database mapping can indicate that beam squinting has occurred in the first measurement occasion when the first measurement exceeds the first measurement threshold. Furthermore, the database mapping can indicate that spatial non-stationarity has occurred in the first measurement occasion when a second measurement exceeds a second measurement threshold. In another example, the database mapping can indicate that spatial non-stationarity has occurred in the first measurement occasion when the measurement exceeds a second measurement threshold.

In some instances, the first measurement threshold and/or the second measurement threshold can be a reference signal received power (RSRP) threshold, a signal-to-interference-plus-noise ratio (SINR), a received signal strength indicator (RSSI) threshold, or a path loss (PL) threshold.

In some instances, the CSI report can include a center frequency associated with the first frequency region and a bandwidth associated with the first frequency region.

A method performed or performable by a UE for wireless communication is described. The method may include receiving, from a base station, a first CSI configuration message associated with a plurality of sub-array configurations of an antenna array. Additionally, the method may include performing a first measurement during a first measurement occasion. The first measurement occasion can be associated with a first sub-array configuration of the plurality of sub-array configurations and a first frequency region. Moreover, the method may include transmitting, to the base station, a first CSI report, wherein the first CSI report is based on the first measurement.

A processor (e.g., a standalone processor chipset, or a component of a UE for wireless communication is described. The processor may be configured to, capable of, or operable to perform one or more operations as described herein. For example, the processor may be configured to, capable of, or operable to receive, from a base station, a first CSI configuration message associated with a plurality of sub-array configurations of an antenna array. Additionally, the processor can perform a first measurement during a first measurement occasion. The first measurement occasion can be associated with a first sub-array configuration of the plurality of sub-array configurations and a first frequency region. Moreover, the processor can transmit, to the base station, a first CSI report, wherein the first CSI report is based on the first measurement.

A base station for wireless communication is described. The base station may be configured to, capable of, or operable to perform one or more operations as described herein. For example, the base station may be configured to, capable of, or operable to transmit, to a UE, a first CSI configuration message associated with a plurality of sub-array configurations of an antenna array. Additionally, the base station can receive, from the UE, a first CSI report, wherein the first CSI report is based on a first measurement performed during a first measurement occasion, the first measurement occasion being associated with a first sub-array configuration of the plurality of sub-array configurations and a first frequency region.

### BRIEF DESCRIPTION OF THE DRAWINGS

FIG. 1 illustrates an example of a wireless communications system in accordance with aspects of the present disclosure.

FIG. 2 illustrates a communication flow diagram for determination of frequency-domain visible regions (FD-VR) and spatial-domain visibility region (SD-VRs) in accordance with aspects of the present disclosure.

FIG. 3 illustrates an example implementation of a spatial and frequency domain resource allocation scenario of FD-VR and SD-VRs in accordance with aspects of the present disclosure.

FIG. 4 illustrates an example implementation of a bandwidth partitioning into a plurality of frequency regions in accordance with aspects of the present disclosure.

FIG. 5 illustrates an example database mapping associated with threshold-based bitmap indicators in accordance with aspects of the present disclosure.

FIG. 6 illustrates an example of a UE in accordance with aspects of the present disclosure.

FIG. 7 illustrates an example of a processor in accordance with aspects of the present disclosure.

FIG. 8 illustrates an example of an NE in accordance with aspects of the present disclosure.

FIG. 9 illustrates a flowchart of method performed by a UE in accordance with aspects of the present disclosure.

### DETAILED DESCRIPTION

The present disclosure provides a technology for UEs to determine and report CSI in next-generation wireless communication systems, particularly those employing very large antenna arrays and large carrier bandwidths, such as in future 6G networks.

Traditional wireless communication systems may face significant challenges related to beam squinting and spatial non-stationarity, when operating with large antenna arrays and wide bandwidths. With regards to beam squinting, in wideband systems, a transmitted beam's direction changes with signal frequency. This causes the beam gain to significantly degrade over a portion of the system's subcarriers, especially edge frequencies. Consequently, a beam may only be effective over a specific frequency-domain visible region (FD-VR). With regards to spatial non-stationarity, with very large antenna arrays, the channel characteristics (e.g., path loss, observed clusters) may not be consistent across all antenna elements. Different parts of the antenna array may be responsible for viewing or otherwise evaluating different propagation environments or even different UEs. This means that the energy from a UE may only be focused on a specific spatial-domain-visibility region (SD-VR) of the antenna array. Existing CSI reporting frameworks either incur significant overhead when trying to capture these complex channel characteristics or require overly complete feedback, making efficient resource allocation difficult.

The present disclosure relates to methods for a UE to jointly determine and report both SD-VRs and FD-VRs. The UE can report both SD-VRs and FD-VRs through a refined CSI configuration and reporting mechanism. In some implementations, a UE operates by first receiving a CSI configuration message from a base station. The CSI configuration can be associated with a plurality of distinct sub-array configurations of an antenna array, where each such sub-array configuration can be characterized by a different number of antenna ports, different number of antenna elements, or a different downlink transmission power value. The UE then performs measurements during designated measurement occasions. Each measurement occasion can be linked to one of these sub-array configurations and a specific frequency region. The frequency region can be larger than a CSI subband (e.g., 4, 8, 16, or 32 resource blocks (RBs)). For example, the frequency region can be larger than 32 resource blocks to facilitate characterization over wider bandwidths. Based on these measurements, the UE generates and transmits a CSI report, which can include details such as the center frequency and bandwidth of the measured frequency region. One or more aspects of the present disclosure also supports SBFD operations, allowing the UE to receive separate CSI configuration messages for different symbol types, such as downlink (DL)-only symbols instead of receiving SBFD symbols. For the SBFD symbols, the relevant frequency region can be partitioned into downlink and uplink sub-bands. For efficient reporting, the CSI configuration can include measurement thresholds, enabling the UE to determine an array of bits indicating whether its measurements surpass these thresholds, thereby compactly conveying information related to phenomena such as beam squint or spatial non-stationarity.

The present disclosure offers several advantages over prior techniques, which include improved resource allocation, reduced interference, improved throughput, energy efficiency, and reduced reporting overhead. With regards to improved resource allocation, by providing the network with detailed information about FD-VRs and SD-VRs, the technology enables more precise and efficient allocation of frequency and spatial resources. With regards to reduced interference, the knowledge of these visible regions allows the network to serve different UEs via distinct SD-VRs and/or FD-VRs, leading to significantly lower inter-user interference. With regards to improved throughput, the ability to delineate and report visible regions facilitates more effective multiple-user multiple input multiple output (MIMO) user pairing and beamforming, optimizing system capacity and throughput. With regards to energy efficiency, instead of requiring highly complex and energy-intensive beamforming architectures to counteract beam squint and spatial non-stationarity, the proposed signaling and reporting framework allows for more intelligent network scheduling and adaptation, potentially leading to a more energy-efficient and cost-effective overall system. With regards to reduced reporting overheard, by using threshold-based bitmap indicators for phenomena like beam squint and spatial non-stationarity, the UE can provide crucial channel state information in a more compact format, reducing CSI reporting overhead compared to prior, more complete feedback mechanisms.

With regards to beam squinting, the technology provides a technical means for precise channel characterization by enabling the UE to perform measurements across specifically defined frequency regions. The CSI configuration message can define these regions with detail, for instance, using a resource indication value (RIV) to specify the size and location of the frequency region. This controlled acquisition of channel measurements across substantial, clearly demarcated portions of the spectrum allows the system to gather specific data on how channel quality, and therefore effective antenna gain, varies. Reporting this information, which can include the center frequency and bandwidth of the measured region, furnishes the network with technically grounded data crucial for pinpointing where beam squint impacts signal quality. Furthermore, the system enables the identification and reporting of FD-VRs. This is achieved by configuring the UE to perform measurements using the same sub-array configuration but across different frequency regions. This allows the UE to generate CSI reports that reflect how the channel, as seen by a consistent antenna setup, changes with frequency. Such frequency-partitioned feedback provides a technical mechanism for the network to discern across which parts of the wideband carrier a particular beam maintains its effectiveness and where its performance degrades due to squint, enabling targeted network responses like frequency-selective scheduling. To convey this understanding with improved efficiency, the technology incorporates a mechanism for reporting based on measurement thresholds predefined database mappings. This transformation of detailed measurement data into a compact, synthesized indicator is a technical method for alerting the network to squint-affected frequency segments without the burden of extensive raw data transmission, thereby supporting more agile and efficient network adaptation.

With regards to spatial non-stationarity, in systems with physically very large antenna arrays, the assumption that the wireless channel characteristics (like path loss, angle of arrival, or multipath scatterers) are uniform across all elements or segments of the array often breaks down. Example implementations of aspects of the present disclosure may provide technical solutions to this problem by enabling targeted channel probing for distinct antenna sub-arrays, facilitating the identification of spatially-variant channel quality, and allowing for efficient indication of spatial non-stationarity, thus empowering the network to optimize resource utilization across large, non-uniform arrays. The UE can perform channel probing specific to different segments of a large antenna array by associating CSI configurations and UE-performed measurements with a plurality of sub-array configurations. These sub-array configurations can be distinct in their physical characteristics, such as employing a different number of antenna ports or different downlink transmission power values. By performing measurements tied to each such designated sub-array configuration, the UE gathers channel state information that specifically reflects the propagation conditions experienced by that particular portion or operational mode of the array. This provision of spatially granular channel data can be a technical means to directly address and quantify channel non-stationarity. Building on this, the system facilitates the identification and reporting of spatially-variant channel quality. The UE can be configured to perform measurements for different sub-array configurations over the same frequency region. The resulting CSI report then inherently contains information reflecting these diverse spatial channel conditions. This is a technical mechanism that allows the base station to discern which sub-arrays possess a favorable communication path to the UE and which are less effective, enabling informed decisions such as activating only optimally positioned sub-arrays for transmission, thereby improving power efficiency and beamforming accuracy.

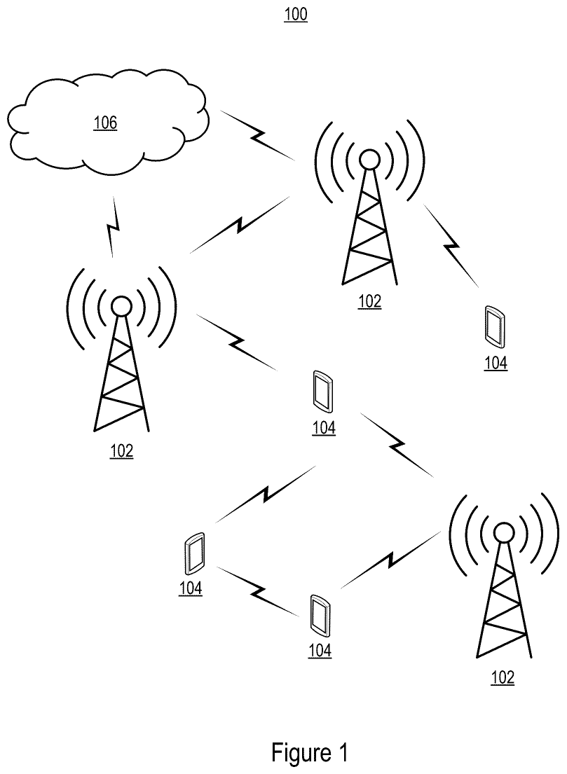

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a next-generation (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

In some implementations, an NE 102 may be implemented in a disaggregated architecture (e.g., a disaggregated base station architecture, a disaggregated RAN architecture), which may be configured to utilize a protocol stack that may be physically or logically distributed among multiple network entities (e.g., NEs 102), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, an NE 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), or any combination thereof. An RU may also be referred to as a radio head, a smart radio head, a remote radio head (RRH), a remote radio unit (RRU), or a transmission reception point (TRP). The split of functionality between a CU, a DU, and an RU may be flexible and may support different functionalities depending on which functions (e.g., network layer functions, protocol layer functions, baseband functions, RF functions, or any combinations thereof) are performed at a CU, a DU, or an RU.

One or more components of the NEs 102 in a disaggregated RAN architecture may be co-located, or one or more components of the NEs 102 may be located in distributed locations (e.g., separate physical locations). Additionally, or alternatively, in some examples, one or more of the NEs 102 of a disaggregated RAN architecture may be implemented as virtual units (e.g., a virtual CU (VCU), a virtual DU (VDU), a virtual RU (VRU)).

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

The wireless communications system 100 may be configured to support ultra-reliable communications or low-latency communications, or various combinations thereof. For example, the wireless communications system 100 may be configured to support ultra-reliable low-latency communications (URLLC). The UEs 104 may support ultra-reliable, low-latency, or critical functions. Ultra-reliable communications may include private communication or group communication. Support for ultra-reliable, low-latency functions may include prioritization of services, and such services may be used for public safety or general commercial applications. The terms ultra-reliable, low-latency, and ultra-reliable low-latency may be used interchangeably herein.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a CP. A first numerology (e.g., μ=0) may be associated with a first subcarrier spacing (e.g., 15 kHz) and a normal CP. In some implementations, the first numerology (e.g., p=0) associated with the first subcarrier spacing (e.g., 15 kHz) may utilize one slot per subframe. A second numerology (e.g., μ=1) may be associated with a second subcarrier spacing (e.g., 30 kHz) and a normal CP. A third numerology (e.g., μ=2) may be associated with a third subcarrier spacing (e.g., 60 kHz) and a normal CP or an extended CP. A fourth numerology (e.g., μ=3) may be associated with a fourth subcarrier spacing (e.g., 120 kHz) and a normal CP. A fifth numerology (e.g., μ=4) may be associated with a fifth subcarrier spacing (e.g., 240 kHz) and a normal CP.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal CP, a slot may include 15 symbols. For an extended CP (e.g., applicable for 60 kHz subcarrier spacing), a slot may include 12 symbols. The relationship between the number of symbols per slot, the number of slots per subframe, and the number of slots per frame for a normal CP and an extended CP may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHZ-52.6 GHz), FR3 (7.125 GHZ-24.25 GHz), FR4 (52.6 GHZ-114.25 GHz), FR4a or FR4-1 (52.6 GHZ-71 GHz), and FR5 (114.25 GHz-300 GHz). In some implementations, the NEs 102 and the UEs 104 may perform wireless communications over one or more of the operating frequency bands. In some implementations, FRI may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FRI may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In some implementations, the UE 104 is specifically configured, for instance through executable instructions stored in memory, to manage the reception and interpretation of CSI configuration messages. Such messages can define a plurality of sub-array operational modes, potentially varying in antenna port numbers or transmission power values and specify measurements across wide frequency regions. The configured processors further direct the UE's measurement activities according to these configurations, process the gathered data, which may involve comparison against predefined measurement thresholds to generate concise bitmap indicators of channel characteristics like beam squint or spatial non-stationarity, and orchestrate the formulation and transmission of comprehensive CSI reports, including any necessary adjustments for different symbol types or duplexing schemes such as SBFD.

In some implementations, the UE integrates technology enabling it to perform channel state measurements over a first frequency region that is substantially wide, for example greater than 32 resource blocks. This capability relies on specialized UE receiver architectures and signal processing algorithms adept at analyzing channel properties across such extended bandwidths. Furthermore, the underlying technology facilitates interaction with antenna systems that utilize a plurality of sub-array configurations. This encompasses the UE's capacity to process and interpret signals associated with a first sub-array configuration having a first number of antenna ports, and similarly for a second sub-array configuration that employs a different, second number of antenna ports, thereby allowing for detailed channel evaluation pertinent to varying effective antenna apertures at the transmitting end.

In some implementations, the UE's measurement capabilities are designed to operate effectively even when different sub-array configurations, defined within the CSI framework, are associated with distinct downlink transmission power values. This means the UE can perform and report measurements (e.g., RSRP, SINR) based on reference signals transmitted using a first power level for one sub-array configuration, and a second, different power level for another sub-array configuration. Such a technological design allows the UE's feedback to implicitly reflect the channel's response to varied transmission power strategies across different spatial segments of the transmitting antenna array, aiding the network in optimizing power allocation in conjunction with spatial resource management.

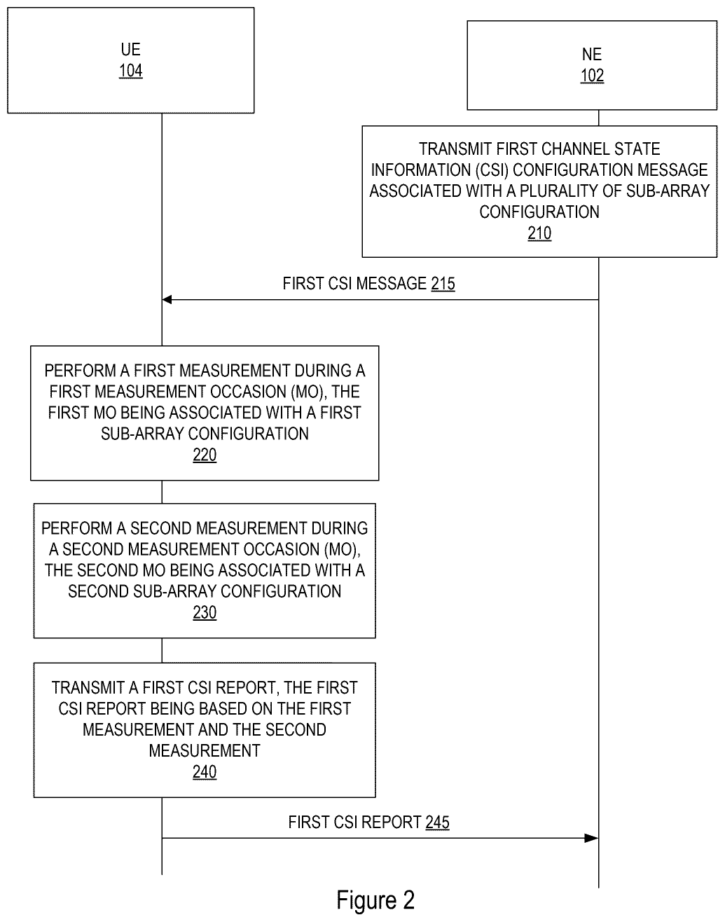

FIG. 2 illustrates a communication flow diagram for determination of FD-VR and SD-VRs in accordance with aspects of the present disclosure. The sequence can involve a network entity NE 102 and a UE 104.

At operation 210, the NE 102 can transmit a first CSI configuration message associated with a plurality of sub-array configuration, resulting in a first CSI message 215 being sent to the UE 104. This operation can involve the formulation and sending of a configuration message to UE 104. The message content can pertain to configuring UE 104 for CSI acquisition and reporting. The plurality of sub-array configuration can indicate or otherwise refer to multiple distinct operational modes or physical partitions of an antenna array, where each sub-array configuration can have a different number of antenna ports, different number of antenna elements, different downlink transmission power values, or a combination thereof.

The first CSI message 215 can carry parameters such as a resource setting indicating the plurality of sub-array configurations, a RIV defining a frequency region's size and location, an RBG size for determining a frequency region, and so on.

At operation 220, the UE 104 can perform a first measurement during a first measurement occasion (MO). The first MO can be associated with a first sub-array configuration in a first frequency region. This operation can be performed in response to receiving the first CSI message 215. The UE 104 can evaluate radio channel characteristics to determine the first measurement. The first MO can define a specific time instance or resource allocation for this measurement. The association with a first sub-array configuration can mean that the measurement is tailored to or focused on channel conditions relevant to that specific antenna configuration from the plurality of sub-array configuration as indicated by the NE 102.

At operation 230, the UE 104 can perform a second measurement during a second MO. The second MO can be associated with a second sub-array configuration. The second measurement can occur at a different time or using different resources than the first measurement. The second sub-array configuration pertains to a different antenna configuration than the first sub-array configuration. For example, the second sub-array configuration could involve a different number of antenna ports, a second frequency region, and/or a different downlink transmission power value. In one example, the second measurement can also be performed over the same first frequency region as the first measurement with different number of antenna ports and/or antenna locations.

At operation 240, the UE 104 can transmit a first CSI report, resulting in the first CSI report 245 being sent to the NE 102. The first CSI report can be generated based on the first measurement and the second measurement. This operation can involve UE 104 preparing and sending a report to the NE 102. The content of this first CSI report can be derived from the outcome of perform a first measurement and can also be based on the outcome of perform a second measurement. For example, the first CSI report 245 can include an array of bits determined based on the first measurement, a second measurement, and a measurement threshold(s). Additionally, the first CSI report 245 can include information about a center frequency and bandwidth of a measured frequency region.

The first CSI report 245 can be conveyed from UE 104 to the NE 102, for example, over an uplink control channel or a shared data channel. The first CSI report 245 can provide the NE 102 with information about the channel conditions as measured and processed by UE 104 according to the received configuration.

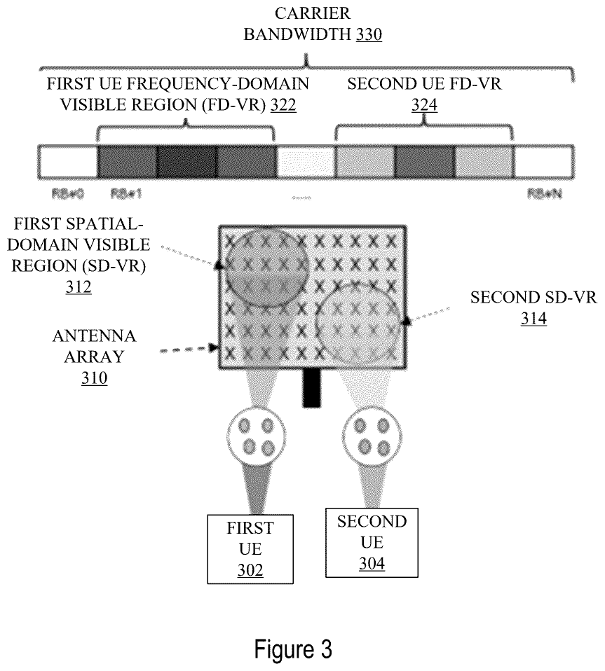

FIG. 3 illustrates an example implementation of a spatial and frequency domain resource allocation scenario in accordance with aspects of the present disclosure. The figure depicts a first UE 302 and a second UE 304 communicating with an antenna array 310. The UE 104 in FIG. 1 is an example of the first UE 302 and second UE 304 in FIG. 3.

In the spatial domain, the antenna array 310 is shown with a plurality of spatial configurations, such as the first SD-VR 312 and the second SD-VR 314. Spatial stationarity in MIMO systems refers to the assumption that the large-scale channel characteristics (e.g., pathloss, observed clusters, blockage status) are consistent across different antenna elements, which implies that the channel behavior at one antenna is similar to that at another antenna. Spatial stationarity is beneficial since it simplifies channel estimation and signal processing. Spatial non-stationarity, on the other hand, appears otherwise, when the channel characteristics are non-consistent across different antenna elements. Spatial non-stationarity can occur when the antenna array size/dimension becomes extremely large. In such case, different parts of the antenna array may have different views of the propagation environment, observing the same channel paths with different power, or even observing different channel paths. One implication of spatial non-stationarity is that different parts of the antenna array may view different UEs, since the energy of each UE may be only focused on a portion of the antenna array, which is described herein as SD-VR.

For example, the first SD-VR 312 can represent a portion of antenna array 310. The first SD-VR 312 can be visually indicated as a highlighted area, for example a circular region, covering a subset of antenna elements or antenna ports within the antenna array 310. The first SD-VR 312 can be associated with the first UE 302, indicating a spatial area of antenna array 310 through which communication with the first UE 302 might be primarily effective. The second SD-VR 314 can represent another portion of antenna array 310. Similar to first SD-VR 312, second SD-VR 314 can be visually indicated as a highlighted area covering a different subset of antenna elements or antenna ports within antenna array 310. The second SD-VR 314 can be associated with the second UE 304. The first SD-VR 312 and second SD-VR 314 can be distinct or can partially overlap on antenna array 310.

In the frequency domain, a carrier bandwidth 330 is shown, which can contain a first FD-VR 322 and a second FD-VR 324. As previously mentioned, beam squint is a phenomenon in which a beam changes its direction with change in the signal frequency and mainly appears in wideband systems. Main impact of beam squint is that the beam-gain of such beam degrades significantly over a portion of system's subcarriers, normally the edge subcarriers. This implies that the beam becomes effective only over a portion of the system subcarriers (e.g., wherein the beam gain is above a certain threshold). Each subcarrier is described herein as a FD-VR. Additionally, beam squint effect can be reduced if network nodes are employing advanced beamforming and/or precoding-decoding architectures. However, these architectures are associated with high energy-consumption and cost. For example, even with the more energy-efficient hybrid beamforming architectures, the network node may need to turn on multiple RF chains to form a frequency-dependent transmit and/or receive beam that reduces beam squint effect.

For example, the first FD-VR 322 can represent a segment of frequency resources within carrier bandwidth 330. In FIG. 3, the first FD-VR 322 can be shown encompassing specific RBs, such as resource blocks RB #1, RB #2, and RB #3. This region can exemplify a band of frequencies over which communication for the first UE 302 is effective. The second FD-VR 324 can represent another segment of frequency resources within carrier bandwidth 330. In FIG. 3, second FD-VR 324 can be shown encompassing other resource blocks, potentially extending up to a resource block RB #N. The first FD-VR 322 and second FD-VR 324 can be distinct, adjacent, or could potentially overlap within carrier bandwidth 330. Carrier bandwidth 330 can represent the total available range of frequencies for communication.

The first UE 302 can perform measurements associated with a first sub-array configuration that includes the first SD-VR 312 of the antenna array 310 and the first FD-VR 322. The second UE 304 can be associated with the second sub-array configuration that includes second SD-VR 314 of the antenna array 310 and the second FD-VR 324 of the carrier bandwidth 330.

Techniques described herein define the desired signaling to determine the SD-VRs and FD-VRs for a UE, which can be used by network scheduler to effectively allocates the FD and SD resources. This can be done by dividing the frequency domain RBs and the antenna array elements or ports into frequency regions and one or more sub arrays. For example, if two UEs are served via different SD-VRs and/or different FD-VRs, those two UEs will have, ideally, zeros inter-user interference, or at least low inter-user interference. Therefore, knowledge of SD-VRs and FD-VRs can help network scheduler with multi-user MIMO user-pairing and resource allocation.

In some examples, the explicit absolute or relative measurement quantities may not be reported by the UE 104. However, the UE 104 can be instructed to determine one or more FD-VRs and SD-VRs (e.g., based on a measured RSRP being above an indicated RSRP threshold) and report a description of the FD/SD visible regions. In some examples, the description of the visible regions can include one or more parameter description of apriori known function type/class (e.g., rect function, sinc function, polynomial), wherein the said description includes estimated parameters of the said function.

In one such example the said rect function is parameterized with a center/starting frequency and bandwidth or half-bandwidth of the said visible frequency region. As such, in one such example, upon determination of such visible frequency region based on the received criteria/threshold value, the starting or middle frequency and a cut-off frequency point is reported.

In some other examples, only one or more cut-off frequencies are indicated, wherein the visible region shall be interpreted as any frequency point from the center frequency of a defined band to the said cut-off frequency point. In some such examples, once a visible region is determined or indicated from the center frequency point to the cut-off frequency point, the same visible region is also assumed implicitly at the lower side of the frequency region.

In some examples, the reported visible frequency regions by a UE 104 are assumed to be within the configured or measured frequency band of the said UE. In some other examples, the UE 104 can provide a visible frequency region regardless of its operational frequency band or received signal bandwidth (e.g., reporting a visible frequency region larger than its observable bandwidth or reporting a cut-off frequency outside of its supported BWP or configured DL signal). In some such examples, the UE 104 can predict or infer the frequency pattern or behavior of the frequency points outside of its scheduled band based on the measurements within its bandwidth (e.g., observing curvature of the channel frequency response within its bandwidth and predicting a cut-off frequency outside of its scheduled DL frequency region).

In some examples, a pre-defined FD-VR and/or SD-VR can be associated with a determined or indicated beam (e.g., transmitted in the DL towards a UE). In some examples, the same FD-VR and/or SD-VR can be assumed for a plurality of UEs (potentially with different reception (Rx) beam direction/characteristics) served via the same DL beam for which an indicated FD-VR and/or SD-VR holds. In some such examples, the said FD-VR and/or SD-VR can be obtained by the network node (e.g., gNB) via previous reports of the other UEs over the same beam. In some examples, the said FD-VR and/or SD-VR can be apriori known at the network and indicated (or defined) to the UEs via a dedicated or broadcast/multi-cast signaling.

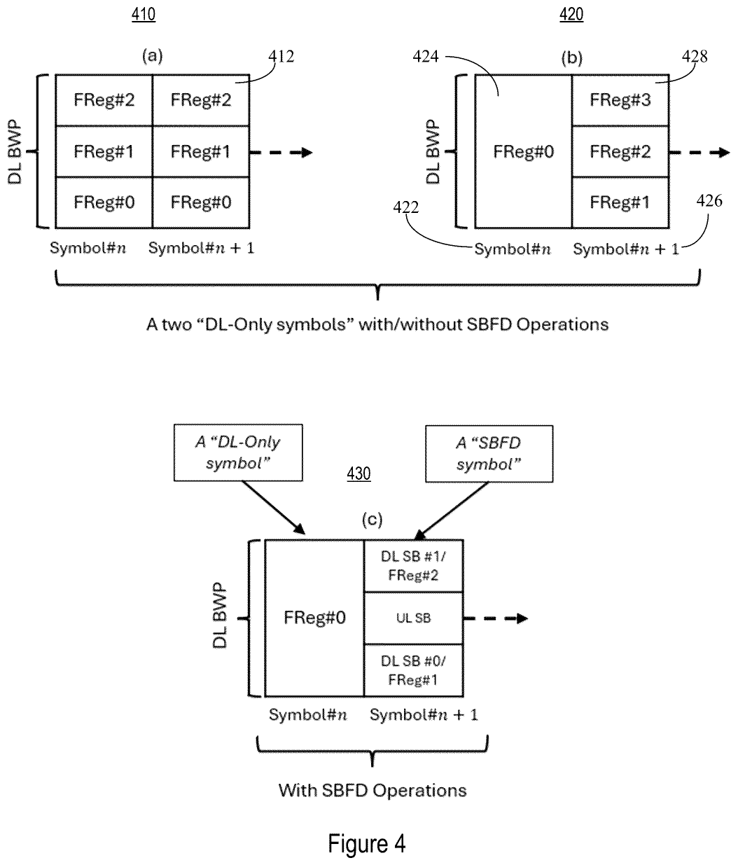

FIG. 4 illustrates an example implementation of a bandwidth partitioning into a plurality of frequency regions in accordance with aspects of the present disclosure. The bandwidth partitioning can be performed with or without SBFD operations.

In the first scenario 410, a uniform frequency region (labeled as “FRegs” in FIG. 4) pattern size is assumed for all symbols. Thus all of the frequency regions have an equal pattern size 412 for the different symbols.

In the second scenario 420, a non-uniform frequency region size is assumed or configured. Thus, a first symbol 422 that is either configured or indicated can have a first frequency region pattern size 424. Additionally, a second symbol 426 that is either configured or indicated can have a second frequency region pattern size 428. In one example, the configuration message may indicate symbol indexes associated with each frequency region pattern size by using a symbol/slot-based bitmap indicator. In another example, the odd symbols/slots can be associated with a first frequency region pattern and even symbols/slots are associated with a second frequency region pattern. In another example, each frequency region pattern can be associated with a time periodicity and the UE 104 may apply both frequency region patterns using an alternating way (e.g., P1P2P1P2). In another example, the UE 104 can determines different frequency region pattern size based on an associated CSI reference signal resource setting.

In the third scenario 430, different frequency pattern size can either be configured or determined for each symbol type.

In some examples, in case of SBFD operations, the UE (e.g., UE 104) may receive a separate CSI configuration message (e.g., one or more of a separate CSI resource, a separate reporting settings, a separate frequency region, a separate measurement thresholds) for each symbol-type. The separate frequency region can either be configurations, indications, or determination. The symbol-type can include DL-only symbols and SBFD symbols. In the DL-only symbols, all frequency resources can be designated as DL resources. In the SBFD symbols, the frequency resources are partitioned into two or more subbands that are non-overlapped, partially overlapped, or fully overlapped. In the SBFD symbols, one or more subbands are designated as DL subbands, and one or more subbands are designated as UL subbands. Additionally, the UE may be configured with the different symbol types (e.g., SBFD and non-SBFD symbols) via a separate SBFD configuration message received. For example, the separate SBFD can be received via system information block #1 (SIB1) during a random-access procedure or a dedicated radio resource control (RRC) signaling.

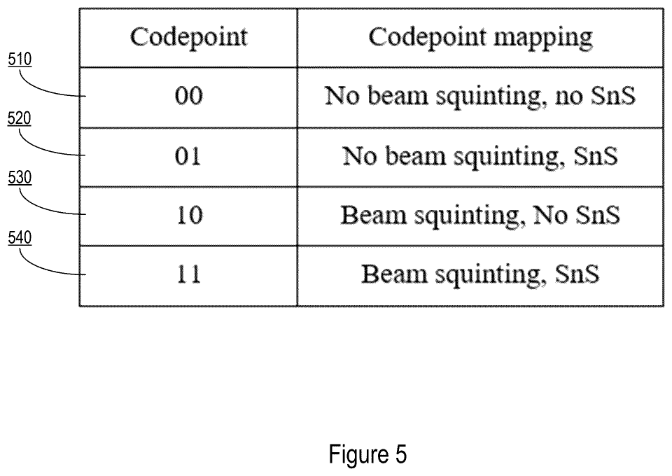

FIG. 5 illustrates an example implementation of a database mapping. This database mapping can be presented as a table comprising a plurality of entries, for example, a first codepoint 510, a second codepoint 520, a third codepoint 530, and a fourth codepoint 540. Each entry can associate a specific codepoint, which can be an example of an array of bits (e.g., ‘00’, ‘01’, ‘10’, ‘11’), with a corresponding codepoint mapping indicating certain channel conditions (e.g., beam squinting, spatial non-stationarity). For example, when the bit array is a first codepoint (i.e., ‘00’), then the UE has determined that there is no beam squinting, and no spatial non-stationarity (labeled as “SnS” in FIG. 5).

For example, first codepoint 510 can show that a codepoint of “00” can correspond to a codepoint mapping of “No beam squinting, no SnS”. This codepoint mapping can indicate an assessment of channel characteristics, such as the absence of detected beam squinting and the absence of detected spatial non-stationarity (or detection of spatial stationarity). For example, second codepoint 520 can show that a codepoint of “01” can correspond to a codepoint mapping of “No beam squinting, SnS”. This codepoint mapping can signify an assessment where no beam squinting is detected, but spatial non-stationarity is detected. For example, third codepoint 530 can show that a codepoint of “10” can correspond to a codepoint mapping of “Beam squinting, No SnS”. This codepoint mapping can denote an assessment where beam squinting is detected, while no spatial non-stationarity is detected. For example, fourth codepoint 540 can show that a codepoint of “11” can correspond to a codepoint mapping of “Beam squinting, SnS”. This codepoint mapping can indicate an assessment where both beam squinting and spatial non-stationarity are detected.

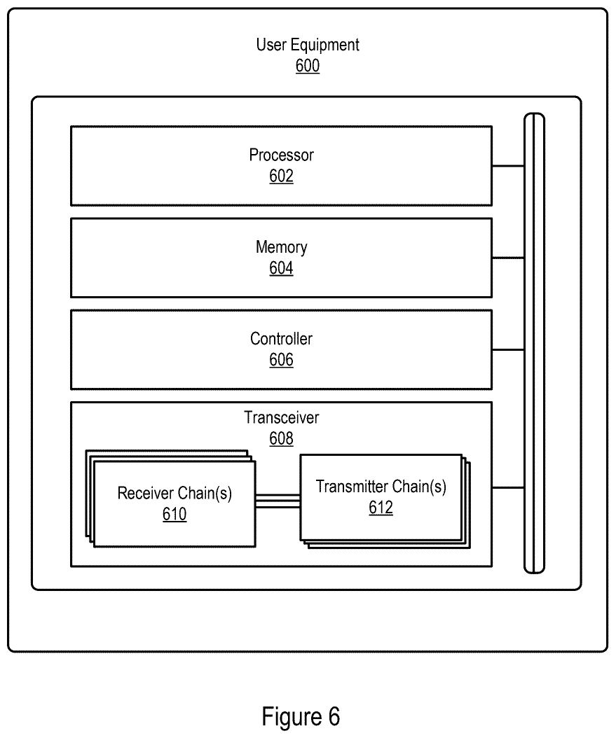

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. The UE 600 may be configured to support a means for receiving, from a base station, a first CSI configuration message associated with a plurality of sub-array configurations of an antenna array. Additionally, the UE 600 may be configured to support a means for performing a first measurement during a first measurement occasion. The first measurement occasion being associated with a first sub-array configuration of the plurality of sub-array configurations and a first frequency region. Moreover, the UE 600 may be configured to support a means for transmitting, to the base station, a first CSI report, wherein the first CSI report is based on the first measurement.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receive the signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

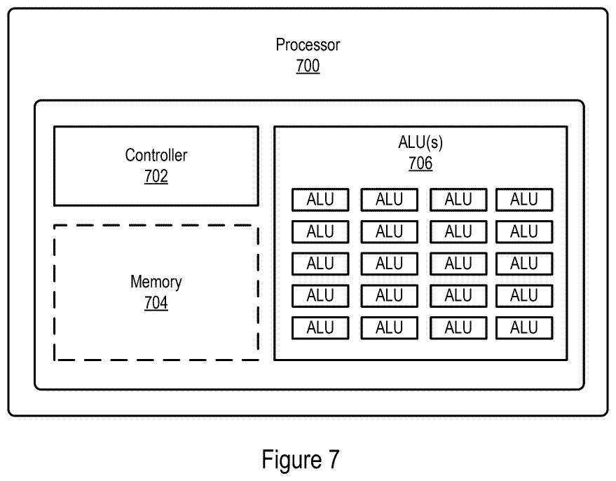

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory address of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, arithmetic logic units (ALUs), and other functional units of the processor 700.

The memory 704 may include one or more caches (e.g., memory local to or included in the processor 700 or other memory, such RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, the controller 702, and the memory 704 may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. The processor 700 may be configured to or operable to support a means for receiving, from a base station, a first CSI configuration message associated with a plurality of sub-array configurations of an antenna array. Additionally, the processor 700 may be configured to support a means for performing a first measurement during a first measurement occasion. The first measurement occasion being associated with a first sub-array configuration of the plurality of sub-array configurations and a first frequency region. Moreover, the processor 700 may be configured to support a means for transmitting, to the base station, a first CSI report, wherein the first CSI report is based on the first measurement.

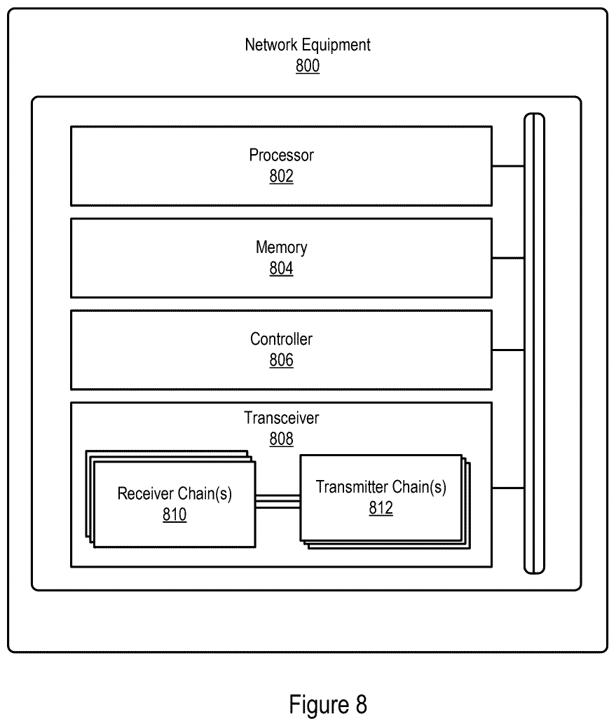

FIG. 8 illustrates an example of a NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein. The NE 800 may be configured to support a means for transmitting, to a UE, a first CSI configuration message associated with a plurality of sub-array configurations of an antenna array. Additionally, the NE 800 may be configured to support a means for receiving, from the UE, a first CSI report. The first CSI reporting can be based on a first measurement. The first measurement is obtained during a first measurement occasion. The first measurement occasion being associated with a first sub-array configuration of the plurality of sub-array configurations and a first frequency region.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receive the signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

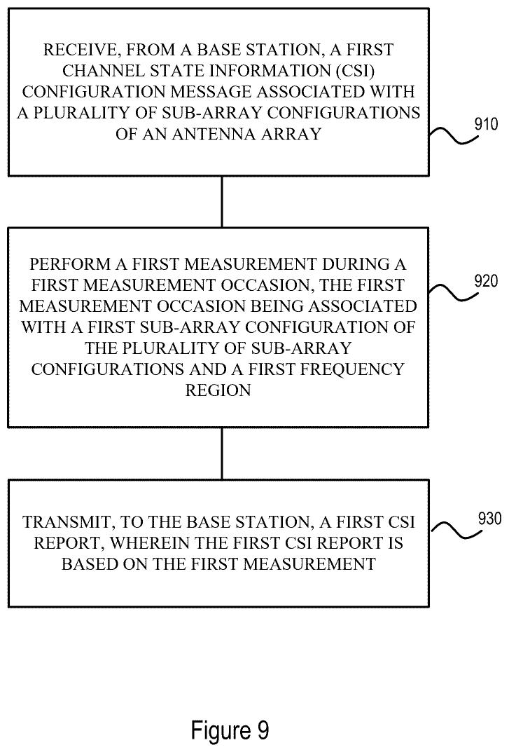

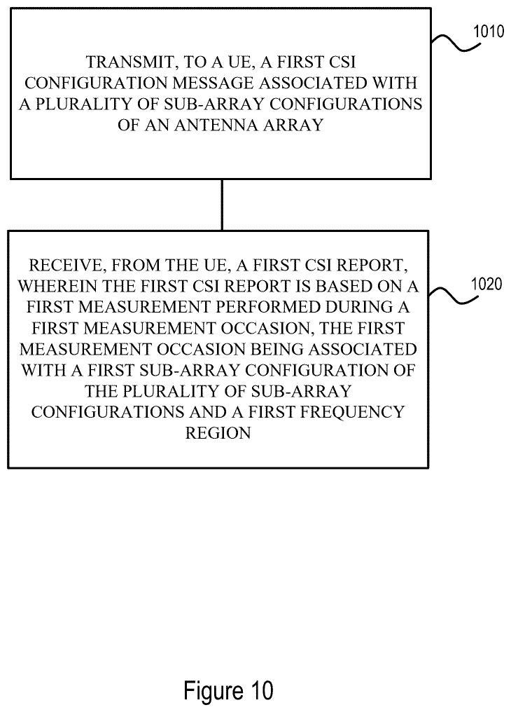

FIG. 9 illustrates a flowchart of a method in accordance with aspects of the present disclosure. The operations of the method may be implemented by a UE (e.g., UE 104, first UE 302) as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At operation 910, the method may include receiving, from a base station, a first CSI configuration message associated with a plurality of sub-array configurations of an antenna array.

In some instances, a first CSI configuration message can include a first RIV. The RIV can indicate a first size (e.g., RB length) of the first frequency region and a first location (e.g., RB start) of the first frequency region.

Additionally, the first CSI configuration message can include the first frequency region and a second frequency region. In some examples, the first frequency region can partially overlap with the second frequency region. In some examples, the first frequency region does not overlap with the second frequency region.

In some instances, the first CSI configuration message can include the first frequency region and a second frequency region. Additionally, the first CSI configuration message can include a second RIV indicating a second size of the second frequency region, where the first size of the first frequency region is different than the second size of the second frequency region.

In some instances, the first CSI configuration message can include a RB group (RBG) size. Additionally, the UE can determine the first frequency region based on the RBG size.

In some instances, the UE can determine the first frequency region based on a downlink (DL) sub-band, a DL bandwidth (BW) part, and/or a carrier BW.

In some instances, the first CSI configuration message can include a sub-array size. Additionally, the UE can determine the first frequency region based on the sub-array size.

In some instances, the first CSI configuration message can include an indication to a CSI-related table. Additionally, the UE can determine the first frequency region based on the CSI-related table.

In some instances, the first CSI configuration message can include a number of frequency regions. Additionally, the UE can determine the first frequency region based on the number of frequency regions.

At 920, the method may include performing a first measurement during a first measurement occasion, the first measurement occasion being associated with a first sub-array configuration of the plurality of sub-array configurations and a first frequency region.

In some instances, the first frequency region can be greater than a predetermined number (e.g., 32, 64, 128) of RBs.

In some instances, the first sub-array configuration can include a first downlink transmission power value. Additionally, a second sub-array configuration of the plurality of sub-array configurations can include a second downlink transmission power value that is different than the first downlink transmission power value.

In some instance, the UE 104 can perform one or more measurements based on one or more CSI measurement metrics (e.g., L1-RSRP, L1-SINR, L1-RSSI) for each measurement occasion. The measurement occasion (e.g., first measurement occasion) can be defined as a combination between a configured CSI reference signal (CSI-RS) resource (or a transmission hypothesis) and a frequency region that is either configured or determined. Each transmission hypothesis can be associated with a configured sub-array (e.g., different number of antenna elements, different number of antenna ports) and/or a different downlink transmission power, or a combination thereof. In case of SBFD operations, the measurement occasions of different symbol types may be indexed separately. In some examples, one or more CSI-RS resources or transmission hypothesis can be associated with a configured sub-array, and each sub-array may comprise different number of antenna elements, different number of antenna ports, different downlink transmission power, or a combination thereof.

In some instances, the UE 104 can combine received channel measurements of one or more measurement occasions and derive one or more CSI measurement metrics based one the combined channel measurements. In one example, the UE 104 can combine channel measurements of a plurality of measurement occasions associated with a separate frequency region and a same transmission hypothesis. In another example, the UE 104 can combine channel measurements of a plurality of measurement occasions associated with a separate transmission hypothesis and a same frequency region. Additionally, the UE can combine the channel measurements of measurement occasions if time difference between combined measurement occasions is less than or equal to a configured or indicated time threshold. Moreover, the UE can combine the channel measurements of measurement occasions if time difference between combined measurement occasions fall within a configured or indicated time period (e.g., within a same slot/subframe). The combined measurements indexes may extend on those of actual measurements (e.g., following a configured rule) or may be indexed and/or reported separately.

At 930, the method may include transmitting, to the base station, a first CSI report, wherein the first CSI report is based on the first measurement.

In some examples, the UE 104 can be configured to report one or more measurements for each measurement occasion. In some examples, the UE 104 can report the measurement occasion indexes and associated absolute/differential measurement values corresponding to selected Q≥1 measurement occasions (e.g., selected based on a maximum/minimum/preferred criterion and/or above/below an indicated threshold). In some implementations, the absolute quantized measurement value of a reference measurement occasion is reported, whereas the differential quantized measurement values of other measurement occasions are reported (i.e., as difference to said reference measurement occasion). The reference measurement occasion can be indicated within the configuration message, or the reference measurement occasion might be configured as the first measurement occasion. The reference measurement occasion can also be indicated within the selected (maximum/minimum/preferred, and/or above/below) measurement occasion, where the index of the selected reference measurement occasion is reported with the CSI measurements report. In some examples, the UE 104 can report the measurements corresponding to a transmission hypothesis within an associated CSI reporting sub-configuration (i.e., each CSI reporting sub-configuration is associated with a TH index).

In some instances, the first sub-array configuration of the plurality of sub-array configurations can include a first number of antenna ports. Additionally, a second sub-array configuration of the plurality of sub-array configurations can include a second number of antenna ports. Moreover, the UE can perform a second measurement during a second measurement occasion. The second measurement occasion can be associated with the second sub-array configuration and the first frequency region. Furthermore, the first CSI report can be further based on the second measurement for the second measurement occasion.

In some instances, the UE 104 can generate the CSI report based on the first measurement and the second measurement.

In some instances, the first CSI configuration message can be for a first symbol type. Additionally, the UE 104 can determine the first frequency region based on the first symbol type.

For example, the first symbol type can be associated with DL-only symbols, and the first frequency region can be designated as a DL resource. Moreover, the UE 104 can receive, from a base station, a second CSI configuration message for a second symbol type. The second symbol type can be associated with SBFD symbols. Furthermore, the UE 104 can determine a second frequency region based on the second symbol type. The second frequency region can be portioned into a plurality of sub-bands, where a first sub-band in the plurality of sub-bands is designated as a DL sub-band, and a second sub-band in the plurality of sub-bands is designated as an UL sub-band.

In some instances, the UE 104 can perform a second measurement for a second measurement occasion. In one example, the second measurement occasion can be associated with the first sub-array configuration and a second frequency region. Additionally, the UE 104 can generate a second CSI report based on the second measurement for the second measurement occasion. Moreover, the UE 104 can transmit, to the base station, the second CSI report associated with a second symbol type.

In some instances, the first CSI configuration message can include a first measurement threshold. Additionally, the UE 104 can determine, using a database mapping, an array of bits (e.g., bitmap indicator) based on the first measurement and the measurement threshold. The CSI report can include the array of bits. Moreover, the database mapping can indicate that beam squinting has occurred in the first measurement occasion when the first measurement exceeds the first measurement threshold. Furthermore, the database mapping can indicate that spatial non-stationarity has occurred in the first measurement occasion when a second measurement exceeds a second measurement threshold. In another example, the database mapping can indicate that spatial non-stationarity has occurred in the first measurement occasion when the measurement exceeds a second measurement threshold.

In some examples, the UE 104 may report an array of bits (e.g., bitmap indicator), wherein each bit corresponds to a measurement occasion. For example, a bit value of “1” indicates that a measurement value is above/below an indicated threshold, while a bit value of “0” indicates that a measurement value is below/above an indicated threshold. The threshold can be configured or indicated within the configuration message. In some examples, the UE 104 can report a separate bitmap for measurements corresponding to a transmission hypothesis within an associated CSI reporting sub-configuration.

In some instances, the first measurement threshold and/or the second measurement threshold can be a RSRP threshold, a SINR threshold, a RSSI threshold, and/or a PL threshold.

In some instances, the CSI report can include a center frequency associated with the first frequency region and a bandwidth associated with the first frequency region. For example, the explicit absolute or relative measurement quantities are not reported by the UE. Instead, the UE can be instructed to determine one or more of FD-VRs and SD-VRs (e.g., based on a measured RSRP being above an indicated RSRP threshold) and report a description of the said FD/SD visible regions. In this example, the description of the visible regions includes one or more parameter description of apriori known function type/class (e.g., rect function, sinc function, polynomial), where the said description includes estimated parameters of the said function. For example, the rect function can be parameterized with a center/starting frequency and bandwidth or half-bandwidth of the visible frequency region. In another example, only one or more cut-off frequencies are indicated, wherein the visible region shall be interpreted as any frequency point from the center frequency of a defined band to the cut-off frequency point. In another example, once a visible region is determined/indicated from the center frequency point to the cut-off frequency point, the same visible region is also assumed implicitly at the lower side of the frequency region.

In some instances, the UE 104 can receive a CSI configuration message (e.g., first CSI configuration message) from a network node, where the configuration message comprises one or more CSI resource settings and one or more CSI reporting settings. Additionally, the configuration message can include one or more CSI measurement thresholds (e.g., RSRP/SINR/RSSI/PL threshold). Moreover, the configuration message can include one or more configured/indicated frequency regions defining frequency granularity for one or more CSI measurements, as described in FIG. 4.

In some instances, the configuration message may indicate explicitly one or more RB start and one or more RB length that is jointly encoded into an RIV, wherein each RIV defines a frequency region location. The one or more frequency regions may be non/partially overlapped.

In some instances, the configuration message may indicate an RBG size. The RBG defines a consecutive RBs in the frequency domain. Additionally, the UE 104 can determine the frequency regions based on the indicated RBG and DL-subband/BWP/carrier BW size.

In some instances, the UE 104 can determine the RBG size based on size of DL subband/DL BWP/carrier BW size and/or number of indicated antenna-array elements/ports within a CSI resource setting or an associated codebook.

In some instances, the UE may be configured with two, or more, CSI-related tables. For example, a first table for determining the subband size for some CSI subband-based calculations, and a second table determining the frequency region size for FD-VR and/or SD-VR determination. In this case, configuration message may include an indication to which table to use for the determination.

In some examples, the configuration message may indicate the number of frequency regions the associated/corresponding DL subband/DL BWP/carrier BW to contain by dividing the corresponding number of RBs uniformly or almost uniformly.

In some examples, the configuration message may include configured CSI reporting settings. The CSI reporting settings may comprise one or more of sub-reporting settings each associated with one or more of CSI resource settings. The UE 104 may receive a separate frequency region size configuration/indication per CSI sub-reporting setting.

In some instances, if the frequency region configuration/indication is absent, the UE 104 may assume a single frequency region of considered DL subbands/BWP/carrier BW.

In some instances, the UE 104 can be a second network node, and the configuration message can be exchanged between a first and second network nodes via a node-to-node network communication interface.

FIG. 10 illustrates a flowchart of a method in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At operation 1010, the method may include transmitting, to a UE, a first CSI configuration message associated with a plurality of sub-array configurations of an antenna array. The configuration message may include a first measurement occasion. The first measurement occasion being associated with a first sub-array configuration of the plurality of sub-array configurations and a first frequency region.

At operation 1020, the method may include receiving, from the UE, a first CSI report. The first CSI reporting can be based on a first measurement performed during a first measurement occasion. The first measurement being associated with a first sub-array configuration of the plurality of sub-array configurations and a first frequency region.

Aspects of the present disclosure are described in the context of a wireless communications system. Additionally details of one or more implementations of the present disclosure are set forth in the accompanying drawings and the description below. Other aspects and advantages will become apparent from the description, the drawings, and the claims.

The following provides an overview of aspects of the present disclosure:

Example 1 relates to method for wireless communication. The method can be performed by a UE. The method can include receiving, from a base station, a first channel state information (CSI) configuration message associated with a plurality of sub-array configurations of an antenna array. Additionally, the method can include performing a first measurement during a first measurement occasion, the first measurement occasion being associated with a first sub-array configuration of the plurality of sub-array configurations and a first frequency region. Moreover, the method can include transmitting, to the base station, a first CSI report, wherein the first CSI report is based on the first measurement.

Example 2 includes the method of example 1. In this example, the first frequency region is greater than 32 resource blocks (RBs), wherein the first sub-array configuration includes a first number of antenna ports, and wherein a second sub-array configuration of the plurality of sub-array configurations includes a second number of antenna ports.

Example 3 includes the method of example 2. In this example, the method can include performing a second measurement during a second measurement occasion, the second measurement occasion being associated with the second sub-array configuration and the first frequency region, and wherein the first CSI report is further based on the second measurement for the second measurement occasion.

Example 4 includes the method of any of the examples 1 to 3. In this example, the first sub-array configuration includes a first downlink transmission power value, and wherein a second sub-array configuration of the plurality of sub-array configurations includes a second downlink transmission power value that is different than the first downlink transmission power value.

Example 5 includes the method of any of the examples 1 to 4. In this example, the first CSI configuration message includes a first resource indication value (RIV), the RIV indicating a first size of the first frequency region and a first location of the first frequency region.

Example 6 includes the method of example 5. In this example, the first CSI configuration message includes the first frequency region and a second frequency region, wherein the first frequency region partially overlaps with the second frequency region.

Example 7 includes the method of example 5. In this example, the first CSI configuration message includes the first frequency region and a second frequency region, wherein the first CSI configuration message includes a second RIV indicating a second size of the second frequency region, and wherein the first size of the first frequency region is different than the second size of the second frequency region.

Example 8 includes the method of any of the examples 1 to 7. In this example, first CSI configuration message includes a RB group (RBG) size. Additionally, the UE method can include determining the first frequency region based on the RBG size.

Example 9 includes the method of any of the examples 1 to 8. In this example, the method can include determining the first frequency region based on a downlink (DL) subband, a DL bandwidth (BW) part, or a carrier BW.

Example 10 includes the method of any of the examples 1 to 9. In this example, the first CSI configuration message includes a sub-array size. Additionally, the method can include determining the first frequency region based on the sub-array size.

Example 11 includes the method of any of the examples 1 to 10. In this example, the first CSI configuration message includes an indication to a CSI-related table. Additionally, the method can include determining the first frequency region based on the CSI-related table.

Example 12 includes the method of any of the examples 1 to 11. In this example, the first CSI configuration message includes a number of frequency regions. Additionally, the method can include determining the first frequency region based on the number of frequency regions.

Example 13 includes the method of any of the examples 1 to 12. In this example, the first CSI configuration message is for a first symbol type. Additionally, the method can include determining the first frequency region based on the first symbol type, wherein the first symbol type is associated with DL-only symbols, and wherein the first frequency region is designated as a DL resource. Moreover, the method can include receiving, from a base station, a second CSI configuration message for a second symbol type, wherein the second symbol type is associated with Sub-band Full Duplex (SBFD) symbols. Furthermore, the method can include determining a second frequency region based on the second symbol type, wherein the second frequency region is portioned into a plurality of sub-bands, and wherein a first sub-band in the plurality of sub-bands is designated as a DL sub-band, and a second sub-band in the plurality of sub-bands is designated as an uplink (UL) sub-band.

Example 14 includes the method of any of the examples 1 to 13. In this example, the method can include performing a second measurement for a second measurement occasion, the second measurement occasion being associated with the first sub-array configuration and a second frequency region. Additionally, the method can include generating a second CSI report based on the second measurement for the second measurement occasion. Moreover, the method can include transmitting, to the base station, the second CSI report associated with a second symbol type.

Example 15 includes the method of any of the examples 1 to 14. In this example, the first CSI configuration message includes a first measurement threshold. Additionally, the method can include determining, using a database mapping, an array of bits based on the first measurement and the first measurement threshold, and wherein the CSI report includes the array of bits.

Example 16 includes the method of example 15. In this example, the database mapping indicates that beam squinting has occurred in the first measurement occasion when the first measurement exceeds the first measurement threshold, and wherein the database mapping indicates that spatial non-stationarity has occurred in the first measurement occasion when a second measurement exceeds a second measurement threshold.

Example 17 includes the method of example 15. In this example, the first measurement threshold is a RSRP threshold, a SINR, a RSSI threshold, or a PL threshold.

Example 18 includes the method of any of the examples 1 to 17. In this example, the CSI report includes a center frequency associated with the first frequency region and a bandwidth associated with the first frequency region.

Example 19 relates to a UE for wireless communication. The UE can include one or more memories; and one or more processors coupled with the one or more memories and individually or collectively operable to cause the UE to perform the method described in any of the examples 1 to 18.

Example 20 relates to a processor comprising at least one controller coupled with at least one memory and configured to cause the processor to perform the method described in any of the examples 1 to 18.

Example 21 relates to method for wireless communication. The method can be performed by a base station. The method can include transmitting, to a UE, a first CSI configuration message associated with a plurality of sub-array configurations of an antenna array. Additionally, the method can include receiving, from the UE, a first CSI report, wherein the first CSI report is based on a first measurement performed during a first measurement occasion, the first measurement occasion being associated with a first sub-array configuration of the plurality of sub-array configurations and a first frequency region.

Example 22 relates to a base station for wireless communication. The base station can include one or more memories; and one or more processors coupled with the one or more memories and individually or collectively operable to cause the base station to perform the method described in example 21.

Example 23 relates to a processor comprising at least one controller coupled with at least one memory and configured to cause the processor to perform the method described example 21.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The description provided herein, along with the accompanying figures, illustrates certain example implementations and is not intended to encompass all possible implementations within the scope of the claims. As used herein, the term “example” is intended to convey an illustration or instance, and does not imply a preferred or superior implementation. The detailed description includes specific features and elements to facilitate understanding of the implementations described in the present disclosure. However, these implementations may also be realized without some or all of the specified details.

What is claimed is:

1. A user equipment (UE) for wireless communication, comprising:
one or more memories; and
one or more processors coupled with the one or more memories and individually or collectively operable to cause the UE to:
receive, from a base station, a first channel state information (CSI) configuration message associated with a plurality of sub-array configurations of an antenna array;
perform a first measurement during a first measurement occasion, the first measurement occasion being associated with a first sub-array configuration of the plurality of sub-array configurations and a first frequency region; and
transmit, to the base station, a first CSI report, wherein the first CSI report is based on the first measurement.

2. The UE of claim 1, wherein the first frequency region is greater than 32 resource blocks (RBs), wherein the first sub-array configuration includes a first number of antenna ports, and wherein a second sub-array configuration of the plurality of sub-array configurations includes a second number of antenna ports.

3. The UE of claim 2, wherein the one or more processors are further individually or collectively configured to cause the UE to:
perform a second measurement during a second measurement occasion, the second measurement occasion being associated with the second sub-array configuration and the first frequency region, and wherein the first CSI report is further based on the second measurement for the second measurement occasion.

4. The UE of claim 1, wherein the first sub-array configuration includes a first downlink transmission power value, and wherein a second sub-array configuration of the plurality of sub-array configurations includes a second downlink transmission power value that is different than the first downlink transmission power value.

5. The UE of claim 1, wherein the first CSI configuration message includes a first resource indication value (RIV), the RIV indicating a first size of the first frequency region and a first location of the first frequency region.

6. The UE of claim 5, wherein the first CSI configuration message includes the first frequency region and a second frequency region, wherein the first frequency region partially overlaps with the second frequency region.

7. The UE of claim 5, wherein the first CSI configuration message includes the first frequency region and a second frequency region, wherein the first CSI configuration message includes a second RIV indicating a second size of the second frequency region, and wherein the first size of the first frequency region is different than the second size of the second frequency region.

8. The UE of claim 1, wherein the first CSI configuration message includes a RB group (RBG) size, and wherein the one or more processors are further individually or collectively configured to cause the UE to:
determine the first frequency region based on the RBG size.

9. The UE of claim 1, wherein the one or more processors are further individually or collectively configured to cause the UE to:
determine the first frequency region based on a downlink (DL) subband, a DL bandwidth (BW) part, or a carrier BW.

10. The UE of claim 1, wherein the first CSI configuration message includes a sub-array size, and wherein the one or more processors are further individually or collectively configured to cause the UE to:
determine the first frequency region based on the sub-array size.

11. The UE of claim 1, wherein the first CSI configuration message includes an indication to a CSI-related table, and wherein the one or more processors are further individually or collectively configured to cause the UE to:
determine the first frequency region based on the CSI-related table.

12. The UE of claim 1, wherein the first CSI configuration message includes a number of frequency regions, and wherein the one or more processors are further individually or collectively configured to cause the UE to:
determine the first frequency region based on the number of frequency regions.

13. The UE of claim 1, wherein the first CSI configuration message is for a first symbol type, wherein the one or more processors are further individually or collectively configured to cause the UE to:
determine the first frequency region based on the first symbol type, wherein the first symbol type is associated with DL-only symbols, and wherein the first frequency region is designated as a DL resource;
receive, from a base station, a second CSI configuration message for a second symbol type, wherein the second symbol type is associated with Sub-band Full Duplex (SBFD) symbols; and
determine a second frequency region based on the second symbol type, wherein the second frequency region is portioned into a plurality of sub-bands, and wherein a first sub-band in the plurality of sub-bands is designated as a DL sub-band, and a second sub-band in the plurality of sub-bands is designated as an uplink (UL) sub-band.

14. The UE of claim 1, wherein the one or more processors are further individually or collectively configured to cause the UE to:
perform a second measurement for a second measurement occasion, the second measurement occasion being associated with the first sub-array configuration and a second frequency region;
generate a second CSI report based on the second measurement for the second measurement occasion; and
transmit, to the base station, the second CSI report associated with a second symbol type.

15. The UE of claim 1, wherein the first CSI configuration message includes a first measurement threshold, and wherein the one or more processors are further individually or collectively configured to cause the UE to:
determine, using a database mapping, an array of bits based on the first measurement and the first measurement threshold, and wherein the CSI report includes the array of bits.

16. The UE of claim 15, wherein the database mapping indicates that beam squinting has occurred in the first measurement occasion when the first measurement exceeds the first measurement threshold, and wherein the database mapping indicates that spatial non-stationarity has occurred in the first measurement occasion when a second measurement exceeds a second measurement threshold.

17. The UE of claim 15, wherein the first measurement threshold is a reference signal received power (RSRP) threshold, a signal-to-interference-plus-noise ratio (SINR), a received signal strength indicator (RSSI) threshold, or a path loss (PL) threshold.

18. The UE of claim 1, wherein the CSI report includes a center frequency associated with the first frequency region and a bandwidth associated with the first frequency region.

19. A method performed or performable by a user equipment (UE), the method comprising:
receiving, from a base station, a first channel state information (CSI) configuration message associated with a plurality of sub-array configurations of an antenna array;
performing a first measurement during a first measurement occasion, the first measurement occasion being associated with a first sub-array configuration of the plurality of sub-array configurations and a first frequency region; and
transmitting, to the base station, a first CSI report, wherein the first CSI report is based on the first measurement.

20. A base station for wireless communication, comprising:
one or more memories; and
one or more processors coupled with the one or more memories and individually or collectively operable to cause the base station to:
transmit, to a user equipment (UE), a first channel state information (CSI) configuration message associated with a plurality of sub-array configurations of an antenna array; and
receive, from the UE, a first CSI report, wherein the first CSI report is based on a first measurement performed during a first measurement occasion, the first measurement occasion being associated with a first sub-array configuration of the plurality of sub-array configurations and a first frequency region.
